(19) United States
(12) Patent Application Publication
(10) Pub. No.: US 2025/0392683 A1
(43) Pub. Date: Dec. 25, 2025

(54) Vehicle Video Recording Device and Method of Controlling The Same

(71) Applicants: HYUNDAI MOTOR COMPANY, Seoul (KR); KIA CORPORATION, Seoul (KR)

(72) Inventors: Dong Hyuk Jeong, Hwaseong-si (KR); Kyoung Jun Kim, Hwaseong-si (KR); Seok Ju Yeom, Hwaseong-si (KR); Jeong Muk Kang, Hwaseong-si (KR); Sung Hwan Jun, Hwaseong-si (KR); Joo Am Baek, Hwaseong-si (KR)

(73) Assignees: HYUNDAI MOTOR COMPANY, Seoul (KR); KIA CORPORATION, Seoul (KR)

(21) Appl. No.: 18/944,478

(22) Filed: Nov. 12, 2024

(30) Foreign Application Priority Data
Jun. 20, 2024 (KR) 10-2024-0080511

(51) Int. Cl. H04N 7/18; G06V 20/58; H04N 23/66

(52) U.S. Cl. CPC H04N 7/188; G06V 20/58; H04N 23/66

(57) ABSTRACT

Disclosed is a video recording device for a vehicle that may receive motion information of an external object from a motion sensor, and when the external object is detected within a first area or when the external object is determined to enter the first area from a second area within a set time, transmit a wake-up command to a camera and prepare for event recording. When an impact is detected by an impact sensor, the video recording device may determine whether at least one of a distance, a speed, or a direction of the external object satisfies a condition that may cause an impact on the vehicle, determine whether the external object is within a set area in a range of the motion sensor, and determine whether to perform the event recording, thereby storing a video (e.g., only) when there is an actual impact by the external object.

### CROSS-REFERENCE TO RELATED APPLICATION(S)

This application claims the benefit of Korean Patent Application No. 10-2024-0080511, filed on Jun. 20, 2024, which is hereby incorporated by reference as if fully set forth herein.

### TECHNICAL FIELD

The present disclosure relates to a vehicle video recording device and a method of controlling the vehicle video recording device.

### BACKGROUND

A video recording device for a vehicle refers to a device configured to record videos of, for example, situations where the vehicle is traveling or parked.

The video recording device may generally be referred to as a driving video recording device because it is intended mainly to acquire videos or images of an accident or the like that may occur during driving.

To acquire videos or images, the video recording device may (e.g., basically) include a controller, a memory for storing videos or images, and a camera for capturing and recording videos or images.

In general, the video recording device may store a video of the surroundings of a vehicle while the vehicle is traveling, along with data on driving of the vehicle at a time corresponding to the video and, when the occurrence of a set event is detected even while the vehicle is parked, record a video according to the already input settings.

The video recording device for a vehicle, also referred to as a black box (or a dash camera), was initially provided (e.g., only) as an external device, but has recently been embedded as a built-in device in a vehicle before the vehicle is released from a factory.

Such a built-in camera (or simply a built-in cam) may be more effective than the external one in terms of access to driving data of a host vehicle and association with other controllers and may thus be expected to be further increasingly used.

The video recording device may perform always-on recording and event-based recording (or simply “event recording”) while a vehicle is traveling and parked, and may interwork with an audio-video-navigation (AVN) system to configure the system and view stored videos or images.

Currently, the vehicle video recording device may start recording and store videos when an impact is detected through an impact sensor. However, the recording may be started even when there is no actual impact by an external object, causing previously recorded videos stored in a memory to be quickly deleted and accelerating the aging of the storage memory. In addition, an impact notification and stored video transmission function of a connected car service (CCS) provided when storing an image of an impact detected while a vehicle is parked may operate unnecessarily, causing user dissatisfaction. Therefore, the development of a video recording device for a vehicle that may store an impact recording video (e.g., only) when an impact occurs from an external object near the vehicle may be beneficial.

### SUMMARY

An object of the present disclosure is to provide a video recording device for a vehicle that employs a vehicle motion detection technology to perform impact detection-based recording.

An object of the present disclosure is to provide a method of storing a video (e.g., only) when a video recording device for a vehicle determines an (e.g., actual) impact by an external object around the vehicle, thereby minimizing (e.g., preventing) frequent impact detection and enabling efficient memory usage.

The technical objects to be achieved by the present disclosure are not limited to those described above, and other technical objects not described above may also be clearly understood by those skilled in the art from the following description.

According to at least one embodiment of the present disclosure, there is provided a video recording device for a vehicle, including a motion sensor configured to detect a motion of an external object around the vehicle, an impact sensor configured to detect an impact on the vehicle, a camera configured to record a video of surroundings of the vehicle, and a controller. The controller may be configured to receive motion information of the external object from the motion sensor, and, when the external object is detected within a first area or when the external object is determined to enter the first area from a second area within a set time, transmit a wake-up command to the camera to prepare for event recording.

According to at least one embodiment, the event recording may include performing recording when the impact is detected by the impact sensor.

According to at least one embodiment, the controller may be further configured to, when the impact is detected by the impact sensor, determine whether to start the event recording based on whether at least one of a distance of the external object, a speed of the external object, or a direction of the external object satisfies an impact condition of applying an impact to the vehicle.

According to at least one embodiment, the controller may be further configured to, when the impact is detected by the impact sensor, determine whether the external object is in the first area to determine whether to start the event recording.

According to at least one embodiment, the controller may be further configured to, when the external object is not detected by the motion sensor, but the impact is detected by the impact sensor, determine whether the impact is a side impact to determine whether to start the event recording.

According to at least one embodiment, the controller may be further configured to, determine the side impact by a lateral component included in a signal detected by the impact sensor.

According to at least one embodiment, the first area may be set to exclude a false detection prevention area of the motion sensor.

According to at least one embodiment, the first area and the set time may be variable according to parameter information set by a user.

According to at least one embodiment, the parameter information may include a detection distance parameter related to a range of the first area, a false detection distance parameter related to the false detection prevention area of the first area, and a time parameter related to the set time.

According to at least one embodiment of the present disclosure, there is provided a method of controlling a video recording device for a vehicle, the method including starting, by a controller, a parking mode in the video recording device of the vehicle, detecting, by the controller, a motion of an external object around the vehicle using at least one motion sensor of the vehicle, detecting, by the controller, an impact of the vehicle using at least one impact sensor of the vehicle, receiving, by the controller, motion information of the external object from the motion sensor, and when the external object is detected within a first area or when the external object is determined to enter the first area from a second area within a set time, transmitting, by the controller, a wake-up command to a camera to prepare for event recording.

According to at least one embodiment, the event recording may include performing recording when the impact is detected by the impact sensor.

According to at least one embodiment, the method may further include, when the impact is detected by the impact sensor, determining whether to start the event recording based on whether at least one of a distance of the external object, a speed of the external object, or a direction of the external object satisfies an impact condition of applying an impact to the vehicle.

According to at least one embodiment, the method may further include, when the impact is detected by the impact sensor, determining whether the external object is in the first area to determine whether to start the event recording.

According to at least one embodiment, the method may further include, when the external object is not detected by the motion sensor, but the impact is detected by the impact sensor, determining whether the impact is a side impact to determine whether to start the event recording.

According to at least one embodiment, the determining whether the impact is the side impact may include determining the side impact by a lateral component included in a signal detected by the impact sensor.

According to at least one embodiment, the first area may be set to exclude a false detection prevention area of the motion sensor.

According to at least one embodiment, the first area and the set time may be variable according to parameter information set by a user.

According to at least one embodiment, the parameter information may include a detection distance parameter related to a range of the first area, a false detection distance parameter related to the false detection prevention area of the first area, and a time parameter related to the set time.

According to at least one embodiment of the present disclosure described herein, impact-based recording may be performed (e.g., only) when an impact sensor detects an impact, for example, when there is an actual impact applied to a vehicle or when an external object is in a motion sensor detection area, and efficient memory usage may be enabled, increasing the lifespan of memory. In addition, unnecessary transmission of an impact detection storage notification and a recorded video, which are provided by a connected car service (CCS), while a vehicle is parked, may be prevented, reducing or resolving user inconvenience and preventing an unnecessary data fee for video transmission from being incurred.

According to at least one embodiment of the present disclosure described herein, the implementation may be achieved (e.g., merely) with a software modification to a (e.g., typical) video recording device without additional hardware.

The effects that can be achieved from the present disclosure are not limited to those described above, and other effects not described above may also be clearly understood by those skilled in the art from the following description.

### BRIEF DESCRIPTION OF THE DRAWINGS

FIG. 1 is a diagram illustrating a configuration of a video recording device for a vehicle and a vehicle including the video recording device according to an embodiment of the present disclosure.

FIGS. 2A, 2B1, 2B2, 2C1, and 2C2 are diagrams illustrating examples of the division and variation of a motion sensor detection area according to an embodiment of the present disclosure.

FIG. 3 is a flowchart illustrating a flow of operations performed by a video recording device for a vehicle according to an embodiment of the present disclosure.

FIGS. 4A, 4B, 4C, and 4D are diagrams illustrating examples of performing event recording in response to an occurrence of an impact based on a result of detecting an external object in a first area, according to an embodiment of the present disclosure.

FIG. 5 is a table illustrating an example of applying parameters classified by dividing setting steps by sensitivity, when setting a motion sensor detection reference based on which event recording is started, according to an embodiment of the present disclosure.

### DETAILED DESCRIPTION

Hereinafter, embodiments of the present disclosure will be described in detail with reference to the accompanying drawings. The embodiments are not construed as limited to the disclosure and should be understood to include all changes, equivalents, and replacements within the idea and the technical scope of the disclosure.

The terms “module,” “unit,” and/or “-er/or” for referring to elements are assigned and used interchangeably in consideration of the ease of explanation, and thus the terms per se do not necessarily have different meanings or functions. The terms “module,” “unit,” and/or “-er/or” do not necessarily mean (e.g., require) physical separation.

Although terms including ordinal numbers, such as, “first,” “second,” and the like, may be used herein to describe various elements, the elements are not limited by these terms. These terms are (e.g., only) used to distinguish one element from another.

The term “and/or” is used to include any combination of multiple items that are subject to it. For example, “A and/or B” may include all three cases, for example, “A,” “B,” and “A and B.”

When an element is described as “coupled” or “connected” to another element, the element may be directly coupled or connected to the other element. However, it is to be understood that another element may be present therebetween. In contrast, when an element is described as “directly coupled” or “directly connected” to another element, it is to be understood that there are no other elements therebetween.

The singular forms “a,” “an,” and “the” are intended to include the plural forms as well, unless the context clearly indicates otherwise. It is to be further understood that the terms “comprises/comprising” and/or “includes/including” used herein specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the present disclosure pertains. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

In addition, the term “unit,” “control unit,” “control device,” or “controller” is merely a widely used term for naming an element that controls a specific function, and does not mean a generic functional unit. For example, each controller may include a communication device that communicates with another controller or a sensor to control a function assigned thereto, a memory that stores an operating system (OS), a logic command, input/output information, and the like, and one or more processors that perform determination, calculation, computation, decision, and the like that may be beneficial (e.g., are necessary) for controlling a function assigned thereto.

Meanwhile, a processor may include a semiconductor integrated circuit and/or electronic devices that perform at least one or more of comparison, determination, computation, and decision to achieve programmed functions. The processor may be, for example, any one or a combination of a computer, a microprocessor, a central processing unit (CPU), an application-specific integrated circuit (ASIC), an electronic circuitry, and a logic circuitry.

The processor may be electrically connected to the memory, and the processor may load and record data from the memory. The memory and the processor may be integrated or may be physically separated.

Hereinafter, embodiments of the present disclosure will be described in detail with reference to the accompanying drawings.

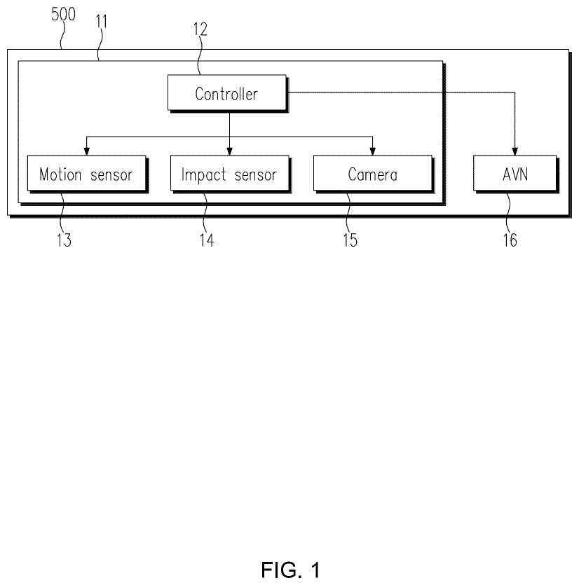

FIG. 1 is a diagram illustrating a configuration of a video recording device for a vehicle and a vehicle including the video recording device according to an embodiment of the present disclosure.

Each component shown in FIG. 1 is provided for illustrative purposes (e.g., only), and it is to be noted that, in actual implementations, more components may be included in a vehicle 500 and a video recording device 11 for a vehicle. In particular, the video recording device 11 according to an embodiment of the present disclosure is provided in an embedded type but is not necessarily limited thereto.

Referring to FIG. 1, according to an embodiment of the present disclosure, the video recording device 11 for a vehicle may include a motion sensor 13 configured to detect a motion of an external object around the vehicle 500, an impact sensor 14, a camera 15 configured to record the surroundings of the vehicle 500, and a controller 12 configured to determine whether to start recording by the camera 15 based on a result of the detection. In addition, there may be an audio-video-navigation (AVN) system 16 communicatively connected to the controller 12.

The motion sensor 13 configured to detect a motion of an external object around the vehicle 500 may include, for example, at least one of a radar, lidar, ultrasonic, or infrared sensor, and may detect a distance between the vehicle 500 and an external object that moves before or behind the vehicle 500 or on the sides of the vehicle 500. The motion sensor 13 may be integrated into a camera module (e.g., the camera 15) or may be separately mounted on the vehicle 500. The motion sensor 13 may be applied (e.g., only) to the front, to front/rear, or to front/rear/left/right sides. Types of sensors that may be included in the motion sensor 13 may not be limited to a specific one, and any type of sensor capable of detecting a motion of external objects outside the vehicle 500 may be included. In addition, it is to be noted that, although the motion sensor 13 dedicated to the video recording device 11 may be used, a radar sensor or the like installed in the vehicle 500 may also be used.

A signal detected by the motion sensor 13 may be a reference based on which the controller 12 may determine whether recording is ready to be performed and recording is performed, and the reference may include, for example, detection distance information, time information about a time at which a moving external object enters a set area within a set time, or the like, which may be set by a user.

The impact sensor 14 configured to detect an external impact to the vehicle 500 may include an acceleration sensor or a gyro sensor, and may determine whether a collision has occurred to the vehicle 500 and the vehicle 500 moves due to the collision. Types of sensors that may be included in the impact sensor 14 may not be limited to a specific one, and any type of sensor capable of detecting an impact to the vehicle 500 may be included. In addition, it is to be noted that, although the impact sensor 14 dedicated to the video recording device 11 may be used, an acceleration sensor or the like installed in the vehicle 500 may also be used.

The camera 15 may include, but is not necessarily limited to, a front camera and a rear camera. The front camera may be installed to capture a video of an area before the vehicle 500, and the rear camera may be installed to capture a video of an area behind the vehicle 500.

For example, the front camera may be installed on a windshield in the cabin of the vehicle 500 near a room mirror, and the rear camera may be installed on a rear window or rear bumper of the cabin of the vehicle 500.

The front camera and the rear camera may support any one of the definitions, for example, high-definition (HD), full HD (FHD), and quad HD (QHD) image quality. It is to be noted that the front camera and the rear camera may not provide the same image quality, and a camera of an advanced driver-assistance system (ADAS) of the vehicle 500 may be used.

In addition, the camera 15 may have an aperture value of F2.0 or less, preferably F1.6 or less. A lower aperture value may allow more light to be gathered, resulting in brighter recordings. In addition, an image tuning technique may be applied to minimize noise and light loss, enabling clear recording even in a dark environment.

The controller 12 may control other components to perform always-on recording while driving (also herein “always-on driving recording) and always-on recording while parked (also herein “always-on parking recording”) and start the recording based on a signal detected by the motion sensor 13 and the impact sensor 14. The controller 12 may use the AVN system 16 to receive, from the user, setting values for conditions for preparing to start recording and performing the recording, through a user menu.

The AVN system 16 may be communicatively connected to the controller 12 (e.g., a built-in camera controller) (e.g., directly) or through a controller of the vehicle 500, and an AVN screen of the AVN system 16 may function as a user interface (UI) for receiving various settings parameters of the video recording device 11 selected by the user.

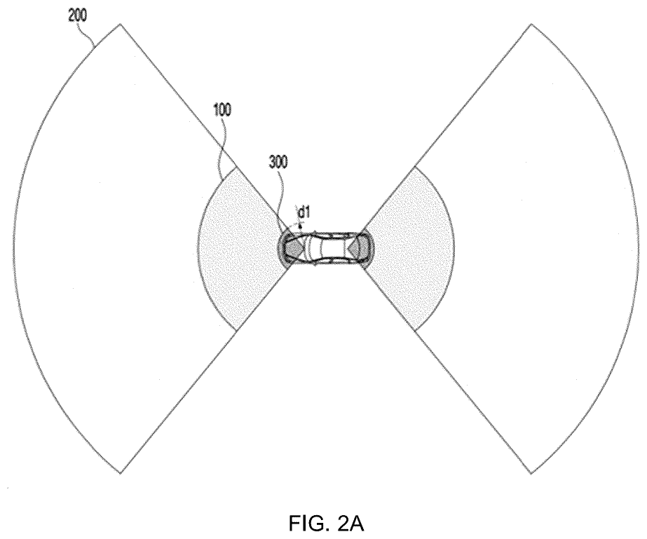

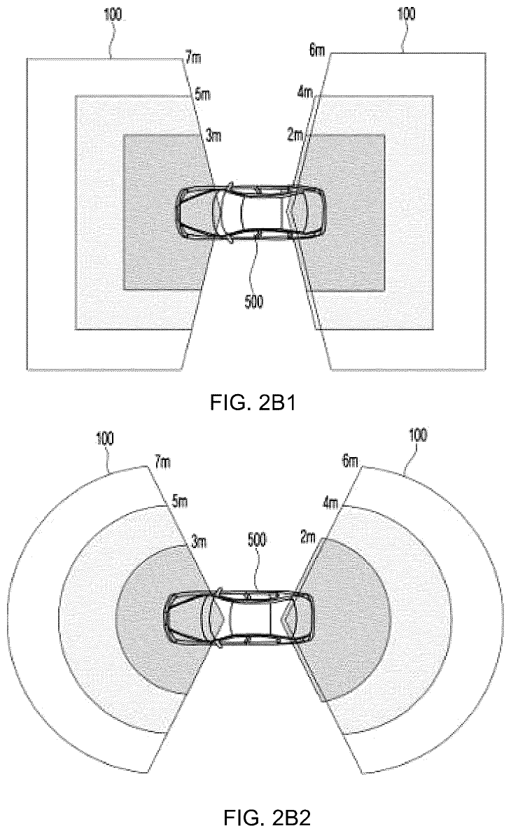

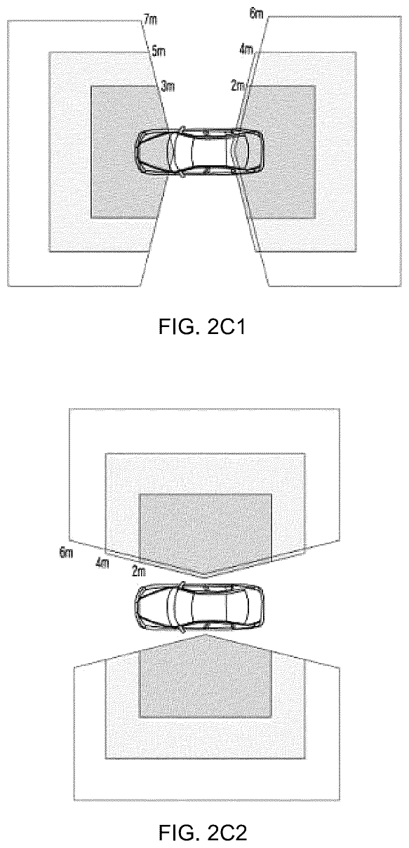

FIGS. 2A, 2B1, and 2B2 are diagrams illustrating examples of the division and variation of a motion sensor detection area according to an embodiment of the present disclosure.

Referring to FIG. 2A, a first area 100 may be, for example, a radial area based on a longitudinal and lateral distance of the vehicle 500 in a video capturing direction of the camera 15 relative to the center of the camera 15, which may correspond to a distance detection parameter based on distance information. Although front and rear areas are illustrated, other areas, such as left and right areas, may also be applied.

In addition, the first area 100 may be set to exclude a false detection prevention area 300 that is determined as within a certain distance dl or less, in order to prevent false detection of the motion sensor 13, which may correspond to a false detection distance parameter.

In addition, the set time may be based on time information about a time predicted to be used for an external object to enter the first area 100 from a second area 200, which may correspond to a time parameter. The distance detection parameter, the false detection distance parameter, and the time parameter may be variable and set by the user.

The second area 200 may be an area that excludes the first area 100 and the false detection prevention area 300 from an entire coverage area that is set to be detected by the motion sensor 13. That is, the second area 200 may be an area having a larger detection distance than the first area 100. For example, currently, a lidar may detect an external object up to a distance of 30 meters (m) to estimate a speed, direction, or the like of the object, and the detection distance parameter of the first area 100, which is the recording reference, may be set at the level of 10 m to 15 m. This is provided (e.g., only) as an example, and it is apparent to a person of ordinary skill in the art that other specific configurations and set values may be applicable.

Referring to FIGS. 2B1 and 2B2, the figures illustrate an example of varying the distance detection parameter and setting the first area 100 by the user. A first area (e.g., the first area 100) detected by the motion sensor 13 may be of various shapes, and the shape of the first area is not limited to the illustrated shape.

FIGS. 2C1 and 2C2 illustrate an example case of applying both a detection area of the motion sensor 13 at the front/rear and a detection area of the motion sensor 13 on the left/right sides, respectively, as shown. When detecting a motion of an external object, a condition of which area the external object is present before and after an impact may be applied by considering collectively the front/rear/left/right sides the motion sensor 13 faces. For example, in a case where an external object approaching the vehicle 500 from the right side gives an impact to the vehicle 500 and then moves to the front of the vehicle 500, this may be detected as an impact although sensors that detect motions of the external object before and after the impact are different, and event recording may then be started.

In addition, in the case of the vehicle 500 having the motion sensor 13 at the front and rear (e.g., only), as shown in FIG. 2C1, when a motion of an external object is not detected by the motion sensor 13 but an impact is detected by the impact sensor 14, whether the impact is a side impact, which is an impact applied on the sides, may be determined, and when it is determined to be the side impact, event recording may be started.

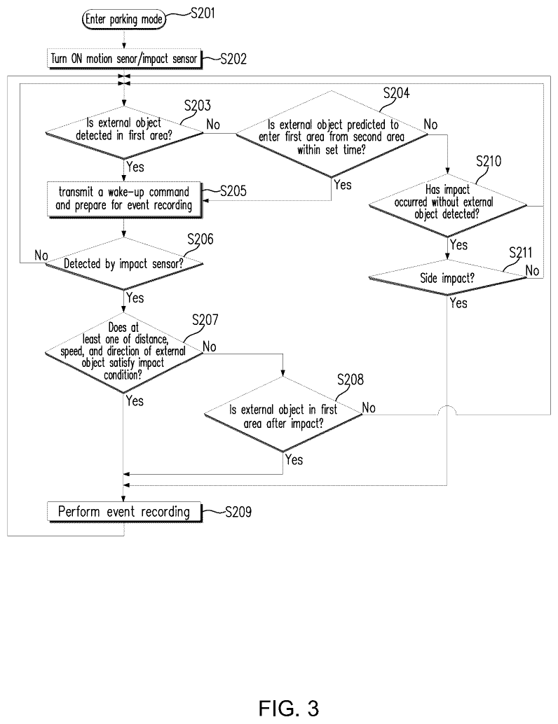

FIG. 3 is a flowchart illustrating a flow of operations performed by a video recording device for a vehicle according to an embodiment of the present disclosure.

Referring to FIG. 3, the video recording device may enter a parking mode in step S201.

The controller 12 may then command the motion sensor 13 and the impact sensor 14 to be turned on and the camera 15 and the controller 12 to enter a sleep mode or be turned off, in step S202. This may be performed to minimize battery consumption of the vehicle 500 in the parking mode.

The controller 12 may check whether an external object is detected within a first area 100 in step S203. When the external object is detected by the motion sensor 13 as being within the first area 100, or when the external object is predicted by the motion sensor 13 to enter the first area 100 from the second area 200 within a set time in step S204, the controller 12 may transmit a wake-up command to the camera 1 and prepare for event recording in step S205. In this case, the event recording may include recording performed when an impact is detected by the impact sensor 14.

In an embodiment, after preparing for the event recording in step S205, the controller 12 may determine whether an impact is detected by the impact sensor 14 in step S206 and, when the impact is detected by the impact sensor 14, may determine whether at least one of the distance, speed, or direction of the external object satisfies an impact condition of the vehicle 500 in step S207. When the impact condition is satisfied, the event recording may be performed in step S209. In this case, when the impact is determined to be detected by the impact sensor 14 in step S206, but at least one of the distance, speed, or direction of the external object is determined not to satisfy the impact condition of the vehicle 500 in step S207, the controller 12 may determine whether the external object is in the first area 100 in step S208. When the external object is in the first area 100, the event recording may be performed in step S209.

In another embodiment, when it is determined that an impact has occurred in step S210, although an external object is not detected by the motion sensor 13 and an external object is not predicted to enter the first area 100 within a set time, the controller 12 may determine whether the impact is a side impact, which is an impact detected on the sides of the vehicle 500, in step S211 and, when it is determined to be the side impact, may determine the impact even if it is not detected by the motion sensor 13 at the front and rear. The event recording may thereby be performed in step S209. The side impact may be determined by a lateral directional component of the vehicle 500 included in a signal detected by the impact sensor 14. For example, when there is an impact component in a Y-axis direction of the acceleration sensor, the side impact may be determined. This embodiment, however, may correspond to a case where the motion sensor 13 is disposed (e.g., only) at the front and rear but not on the left and right sides.

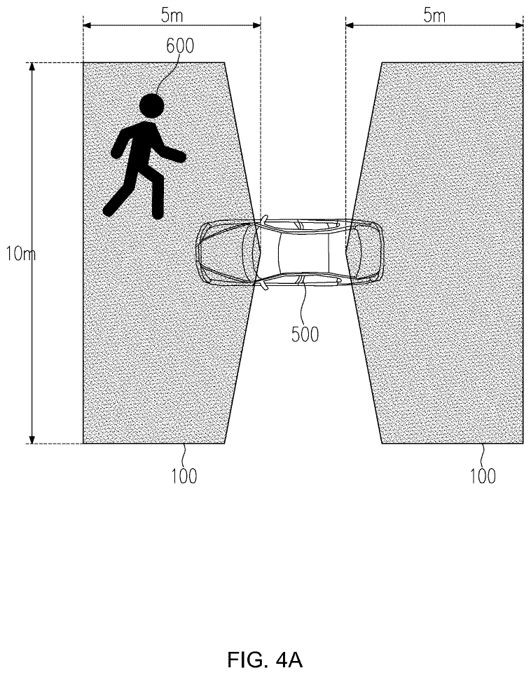

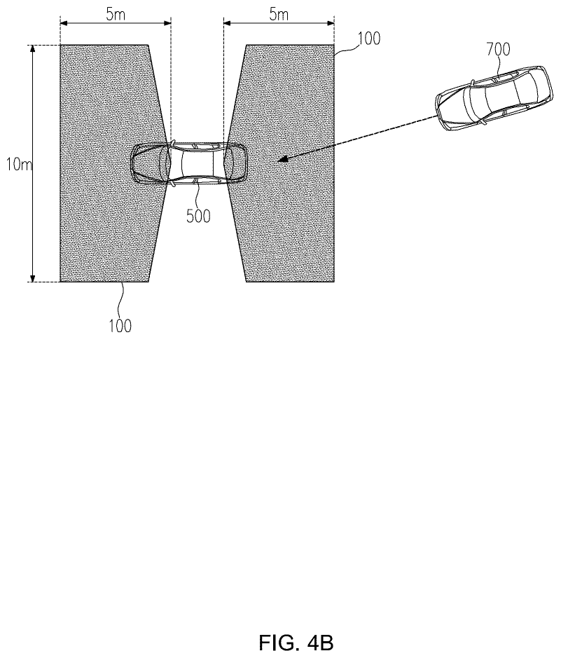

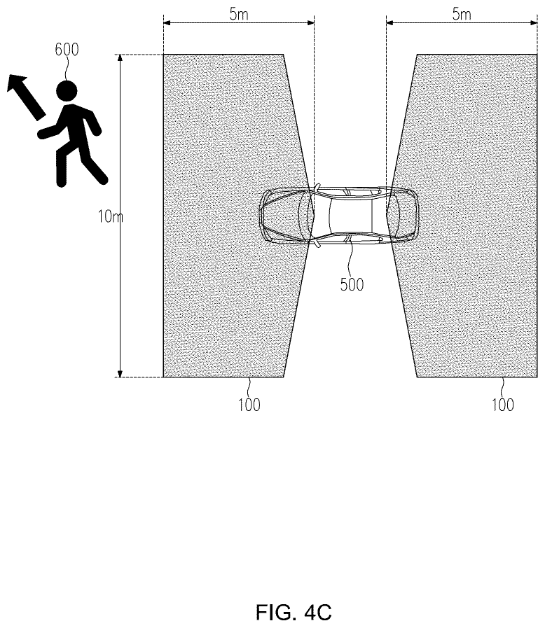

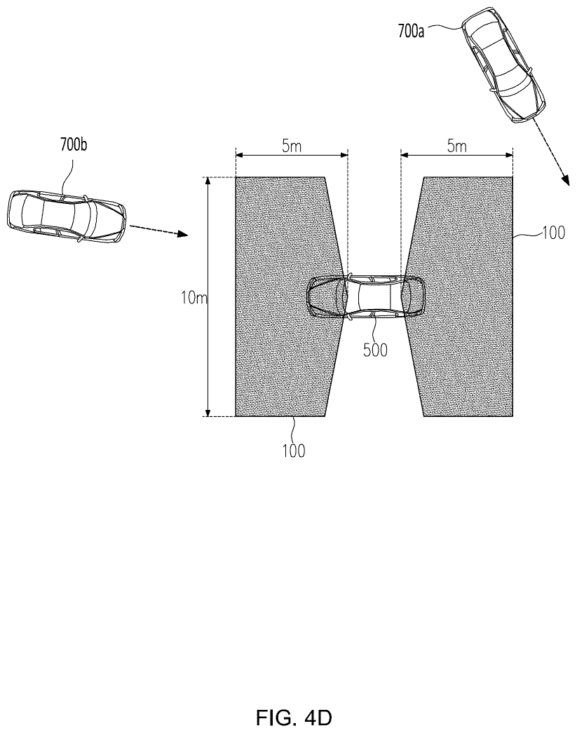

FIGS. 4A, 4B, 4C, and 4D are diagrams illustrating examples of performing event recording in response to an occurrence of an impact based on a result of detecting an external object in a first area, according to an embodiment of the present disclosure.

FIG. 4A illustrates an example case where a first area 100 is set by setting a detection distance parameter of the first area 100 to 5 m, and a person 600, which is an external object, is detected within the first area 100. In this case, a wake-up command may be transmitted to the camera 15, and event recording may be started when an impact occurs.

FIG. 4B illustrates an example case where a first area 100 is set by setting a detection distance parameter of the first area 100 to 5 m and setting a set time, e.g., a time parameter, and a vehicle 700, which is an external object, is predicted to enter the first area 100 within the set time. This case may be a condition that transmits a wake-up command to the camera 15, and event recording may be started when an impact occurs.

FIG. 4C illustrates an example case where a first area 100 is set by setting a detection distance parameter of the first area 100 to 5 m and setting a set time, e.g., a time parameter, and a person 600, which is an external object, is not predicted to enter the first area 100 within the set time. In this case, a wake-up command may not be transmitted to the camera 15, and event recording may not be started even when an impact occurs.

FIG. 4D illustrates an example case where a first area 100 is set by setting a detection distance parameter of the first area 100 to 5 m and setting a set time, e.g., a time parameter, and a vehicle 700a is not heading toward the first area 100 or a vehicle 700b is heading toward the first area 100 but is not able to enter the first area 100 within the set time due to a slow moving speed. In this case, a wake-up command may not be transmitted to the camera 15, and event recording may not be started even when an impact occurs.

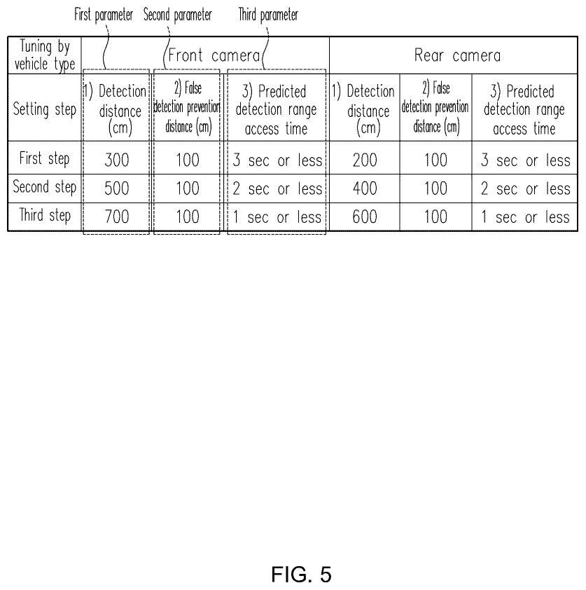

FIG. 5 is a table illustrating an example of applying parameters classified by dividing setting steps by sensitivity, when setting a motion sensor detection reference based on which event recording is started, according to an embodiment of the present disclosure.

FIG. 5 illustrates an example case where the camera 15 includes a front camera and a rear camera. However, examples are not limited thereto, and the camera 15 may be applied (e.g., only) to the front, front/rear, or front/rear/left/right. A first area 100 may be a radial area based on a longitudinal and lateral distance of the vehicle 500 in a video capturing direction of the camera 15 relative to the center of the camera 15, which may correspond to a distance detection parameter based on distance information. In addition, the first area 100 may be set to exclude a false detection prevention area 300 that is detected within a certain distance or less to prevent false detection of the motion sensor 13, which may correspond to a false detection distance parameter. In addition, a set time may be based on time information about a time predicted to be used for an external object to enter the first area 100 from a second area 200, which may correspond to a time parameter. Each parameter information may be variable by the user. In this case, the distance detection parameter, the false detection distance parameter, and the time parameter, which are based on sensitivity, may be defined herein as a first parameter, a second parameter, and a third parameter, respectively.

When setting the first, second, and third parameters based on sensitivity, the user may set the parameter information through a screen of the AVN system 16 in the vehicle 500. For example, the sensitivity may be divided into three levels of level 1 (insensitive), level 2 (moderate), and level 3 (sensitive). However, the example is provided for illustrative purposes (e.g., only), and it is apparent to a person of ordinary skill in the art that other specific examples may be applicable.

It is apparent to a person of ordinary skill in the art that the present disclosure may be embodied in other specific forms without departing from the (e.g., spirit and essential) features of the present disclosure. Accordingly, the above detailed description is not to be construed as limiting in any respect and should be considered illustrative. The scope of the present disclosure is to be determined by a reasonable interpretation of the appended claims, and all changes or modifications within the equivalents of the present disclosure are included in the scope of the present disclosure.

The method(s) according to embodiments described herein may be produced as a computer-executable program, and the program may be stored in a computer-readable recording medium. The computer-readable recording medium may include, for example, a read-only memory (ROM), a random-access memory (RAM), a compact disc ROM (CD-ROM), a magnetic tape, a floppy disk, an optical data storage device, and the like, and may also be implemented in the form of carrier waves (e.g., Internet-based transmission).

The computer-readable recording medium may be distributed across a networked computer system, such that computer-readable code may be stored and executed in a distributed manner. In addition, functional programs, code, and code segments for implementing the method(s) described herein may be readily inferred by programmers of ordinary skill in the art to which the present disclosure pertains.

It is apparent to a person of ordinary skill in the art that the present disclosure may be embodied in other specific forms without departing from the (e.g., spirit and essential) features of the present disclosure.

Accordingly, the above detailed description is not to be construed as limiting in any respect and should be considered illustrative. The scope of the present disclosure is to be determined by a reasonable interpretation of the appended claims, and all changes or modifications within the equivalents of the present disclosure are included in the scope of the present disclosure.

What is claimed is:

1. A video recording device for a vehicle, comprising:
a motion sensor configured to detect a motion of an external object around the vehicle;
an impact sensor configured to detect an impact on the vehicle;
a camera configured to record a video of surroundings of the vehicle; and
a controller,
wherein the controller is configured to
receive motion information of the external object from the motion sensor, and
when the external object is detected within a first area or when the external object is determined to enter the first area from a second area within a set time, transmit a wake-up command to the camera to prepare for event recording.

2. The video recording device of claim 1, wherein the event recording comprises
performing recording when the impact is detected by the impact sensor.

3. The video recording device of claim 1, wherein the controller is further configured to,
when the impact is detected by the impact sensor, determine whether to start the event recording based on whether at least one of a distance of the external object, a speed of the external object, or a direction of the external object satisfies an impact condition of applying an impact to the vehicle.

4. The video recording device of claim 3, wherein the controller is further configured to,
when the impact is detected by the impact sensor, determine whether the external object is in the first area to determine whether to start the event recording.

5. The video recording device of claim 1, wherein the controller is further configured to,
when the external object is not detected by the motion sensor, but the impact is detected by the impact sensor, determine whether the impact is a side impact to determine whether to start the event recording.

6. The video recording device of claim 5, wherein the controller is further configured to
determine the side impact by a lateral component included in a signal detected by the impact sensor.

7. The video recording device of claim 1, wherein the first area is set to exclude a false detection prevention area of the motion sensor.

8. The video recording device of claim 1, wherein the first area and the set time are variable according to parameter information set by a user.

9. The video recording device of claim 8, wherein the parameter information comprises a detection distance parameter related to a range of the first area, a false detection distance parameter related to a false detection prevention area of the first area, and a time parameter related to the set time.

10. A method of controlling a video recording device of a vehicle, the method comprising:
starting, by a controller, a parking mode in the video recording device of the vehicle;
detecting, by the controller, a motion of an external object around the vehicle using at least one motion sensor of the vehicle;
detecting, by the controller, an impact of the vehicle using at least one impact sensor of the vehicle;
receiving, by the controller, motion information of the external object from the motion sensor; and
when the external object is detected within a first area or when the external object is determined to enter the first area from a second area within a set time, transmitting, by the controller, a wake-up command to a camera to prepare for event recording.

11. The method of claim 10, wherein the event recording comprises
performing recording when the impact is detected by the impact sensor.

12. The method of claim 10, further comprising,
when the impact is detected by the impact sensor, determining whether to start the event recording based on whether at least one of a distance of the external object, a speed of the external object, or a direction of the external object satisfies an impact condition of applying an impact to the vehicle.

13. The method of claim 12, further comprising,
when the impact is detected by the impact sensor, determining whether the external object is in the first area to determine whether to start the event recording.

14. The method of claim 10, further comprising,
when the external object is not detected by the motion sensor, but the impact is detected by the impact sensor, determining whether the impact is a side impact to determine whether to start the event recording.

15. The method of claim 14, wherein the determining whether the impact is the side impact comprises
determining the side impact by a lateral component included in a signal detected by the impact sensor.

16. The method of claim 10, wherein the first area is set to exclude a false detection prevention area of the motion sensor.

17. The method of claim 10, wherein the first area and the set time are variable according to parameter information set by a user.

18. The method of claim 17, wherein the parameter information comprises
a detection distance parameter related to a range of the first area, a false detection distance parameter related to the false detection prevention area of the first area, and a time parameter related to the set time.
